(19) United States
(12) Patent Application Publication
(10) Pub. No.: US 2020/0019364 A1
(43) Pub. Date: Jan. 16, 2020

(54) Electronically Customizable Articles

(71) Applicant: Renee Pond, Marietta, GA (US)

(72) Inventor: Renee Pond, Marietta, GA (US)

(21) Appl. No.: 16/579,027

(22) Filed: Sep. 23, 2019

Related U.S. Application Data
(63) Continuation-in-part of application No. 13/972,900, filed on Aug. 21, 2013, now Pat. No. 10,420,379.
(60) Provisional application No. 61/742,884, filed on Aug. 21, 2012.

(51) Int. Cl. G06F 3/14; G06Q 30/06; G09G 5/37; A45C 3/06; A45C 15/00

(52) U.S. Cl. CPC G06F 3/14; G06Q 30/0621; G06F 3/04883; A45C 3/06; A45C 15/00; G09G 5/37

(57) ABSTRACT

Some implementations of this disclosure provide an electronically customizable article comprising a fashion article selected from the group consisting of a handbag, a shoe, glasses, a tie, and a bowtie wherein the fashion article comprises an electronic visual display, a processor, a communication interface for communication between the fashion article and a network, and a non-transitory computer readable medium containing instructions that, when executed by the processor, causes the fashion article to connect to a server over the network, receive data from the server, and display one or more images associated with the data on the electronic visual display.

### RELATED APPLICATIONS

The present application is a continuation-in-part of U.S. application Ser. No. 13/972,900, entitled “Electronically Customizable Articles,” filed Aug. 21, 2013, which issues on Sep. 24, 2019 as U.S. Pat. No. 10,420,379, which claims the benefit of U.S. Provisional Application No. 61/742,884, filed Aug. 21, 2012, which are incorporated herein by reference in its entirety.

It is intended that each of the referenced applications may be applicable to the concepts and embodiments disclosed herein, even if such concepts and embodiments are disclosed in the referenced applications with different limitations and configurations and described using different examples and terminology.

### FIELD OF DISCLOSURE

The present disclosure generally relates to electronically customizable articles.

### BACKGROUND

Most current article options limit consumers to one design or one color and do not provide the option of personalizing the article. Thus, users are forced to collect different articles to meet each wardrobe, home decor, and social event requirement. This may be expensive. Existing options currently on the market that allow for some color, design, and/or style versatility of an article are interchangeable shells, reversible items, and a small selection of interchangeable fabrics. These existing options provide limited color and design versatility for consumers.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the Applicants. The Applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1 illustrates an example environment of the present disclosure for setting or changing the outer appearance of an electronically customizable article;

FIG. 2A illustrates an example of electronically customizable articles;

FIG. 2B illustrates an example of electronically customizable articles;

FIG. 3 illustrates an example computer system which may be used with some embodiments of the present invention;

FIG. 4 shows a schematic representation of the main components of an example computing platform; and

FIG. 5 illustrates a block diagram of a system including a computing device for performing some embodiments of the present disclosure.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Regarding applicability of 35 U.S.C. § 112, ¶ 6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in, the context of electronically customizable articles, embodiments of the present disclosure are not limited to use only in this context.

Consistent with embodiments of the present disclosure, electronically customizable articles may be provided. This overview is provided to introduce a selection of concepts in a simplified form that are further described below. This overview is not intended to identify key features or essential features of the claimed subject matter. Nor is this overview intended to be used to limit the claimed subject matter's scope. Systems and methods of this disclosure allow a user to set or change the outer appearance of an electronically customizable article (e.g., a handbag). Implementations of the electronically customizable articles may include an electronic visual display such as a flat panel display to display a user-selected or created color, design, pattern, image, slideshow, video, or other electronic visual display on the exterior of the article.

In some embodiments, the electronic visual display may form an outer surface of the article. In some implementation, the electronic visual display is integral with the article. In some embodiments, the electronic visual display may be removable from the article.

In some embodiments, the electronic visual display may be a flexible digital display canvas. In some embodiments, the electronic visual display may be a touch screen. In some embodiments, the electronic visual display may be a liquid crystal display (LCD), light emitting diode (LED), organic light-emitting diode (OLED), interferometric modulator display (IMOD), plasma, electronic display screen, active-matrix organic light-emitting diode (AMOLED), electronic paper transparent screens, or any other present or future developed electronic display screen technology.

In some embodiments, the electronically customizable article may serve as a computing device such as a laptop, a smartphone, a mobile telephone, a tablet-style computer, or any other handheld electronic device In some embodiments, the electronically customizable article includes an operating system (OS) and may be configured to run one or more application software. In some embodiments, the electronically customizable article may include Wi-FI, Bluetooth, and GPS capabilities to, among other things, allow the electronically customizable article to connect to the Internet and other Bluetooth-capable devices. In some embodiments, the electronically customizable article may be configured to display multiple or multitasking application display screen abilities.

Implementations of this disclosure may include hardware and software to create a user interface for a user to select or create a visual display to be displayed on the electronically customizable article. The hardware and software for the user interface may be included in the electronically customizable article, a separate computing device, or on a remote server in combination with either the electronically customizable article or a separate computing device. The hardware and software for the graphical user interface are configured to permit the user to select create, or edit images, designs, colors, patterns, and video or media content. In some embodiments, the software for the user interface may be downloaded to the electronically customizable article.

In some embodiments, the hardware and software for the graphical user interface are configured to permit the user to manipulate images through, for example, color, color depth, brightening and contrast adjustments, special effects, multiple image merging, softening options, sharpening abilities, image enhancing, image rotating, selective color changing, options of adding and removing elements, cropping, size and orientation adjustments (e.g., landscape or portrait format) and image layering.

In some embodiments, the hardware and software for the graphical user interface are configured to permit the user to animate portions of a still image (e.g., object in continuous motion with still background).

In some embodiments, the hardware and software for the graphical user interface are configured to permit the user to add lighting-show to still image (e.g., pulsating or flashing light emitted from portions of the image) with transfer and display lighting effect images to article.

In implementations where the hardware and software for the user interface or a portion thereof is embodied in a separate computing device or remote server, the user-selected or created display may be transferred to the electronically customizable article via a wire-based or wireless network. In some embodiments, the wireless network may include a WI-Fl network, a wireless cellular network, a Wi-Max network, a long-range wireless data network, an ad hoc network, a personal area network (PAN) (such as BLUETOOTH), a local area network (LAN), a wide area network (WAN), a metropolitan area network (MAN), one or more portions of the Internet or a combination of two or more of these networks. In some embodiments, the user-selected or created display may be transferred to the electronically customizable article via cable or connectors (e.g., USB cables) or a storage medium such as a flash drive, memory card, USB type C connector, or other data storage device. In some embodiments, display content may be transferred to article via other computing devices such as, for example, a mobile phone, camera or another electronic fashion article utilizing screen mirroring mechanisms and the direct wireless image transferring mechanisms. In some embodiments, the fashion device may incorporate NFC chips to aid in data transfer.

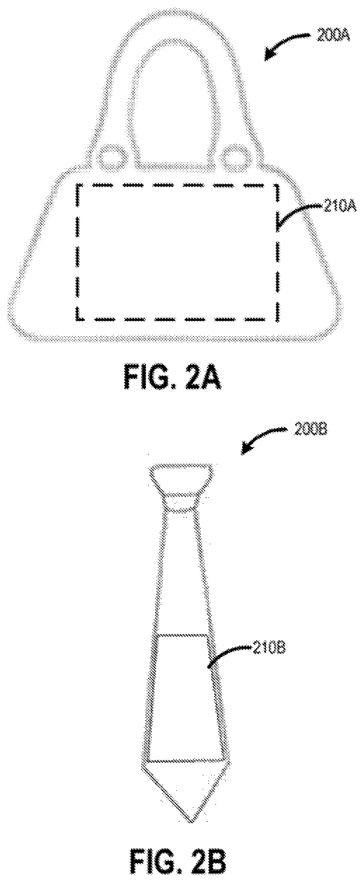

FIGS. 2A-2B illustrate example electronically customizable articles 200A, B respectively. The electronically customizable articles 200A, B may include an electronic visual display 210A, B such as a flat panel display to display a user-selected or created electronic visual display. The electronic visual display on the electronically customizable article may be user-created, downloaded from a remote server, transferred from a local computing device or portable storage media, ordered, or a pre-existing image stored locally (e.g., in the electronically customizable articles) or remotely, for example.

In alternative embodiments, the electronically customizable article 115 may be shoes, all types of purses, bags, hats, belts, bracelets, necklaces, earrings, rings, scarves, sunglass and eyeglass frames, gloves, clothing apparel backpacks, book covers, portfolio cases, ties, bow ties, cufflinks, wallets, laptop lids, name tags, suitcases, briefcases, laptop bags, head phones, head bands and other hair accessories, pet collars, pet leashes, and other pet accessories, undergarments, watches, furniture, luggage, lamps, picture frames, lunch boxes, socks, beverage sleeves, dishware plates, bowls and silverware, key chains, skateboards, roller skates, bikes, diaper bags, all occasion decorations and centerpieces, all writing utensils, all clothing and outerwear and phone and other small electronic cases.

In some embodiments, the electronic visual display may form an outer surface of the article. In some embodiments, alt substantially alt or a portion of the exterior view of the electronically customizable article may comprise an electronic visual display to customize alt substantially alt or a portion of the electronically customizable article, respectively.

In some embodiments, the electronic visual display (e.g., 210A, B) may be integral with the electronically customizable article. In some embodiments, the electronic visual display may be removable from the article.

In some embodiments, the electronic visual display may be a flexible digital display canvas. In some embodiments, the electronic visual display may be a touch screen. In some embodiments, the electronic visual display may be a liquid crystal display (LCD), light emitting diode (LED), organic light-emitting diode (OLED), interferometric modulator display (IMOD), plasma, electronic display screen, active-matrix organic light-emitting diode (AMOLED), electronic paper transparent screens, or any other present or future developed electronic display screen technology. In some embodiments, the electronic fashion article and or visual display may incorporate technologies including, but not limited to, electrovibration technology, 3D touch technology, and/or augmented technology. In this way, in some implementations, these features may provide visual and tactile enhancements which may help aid the visual impaired.

In some embodiments, the user-selected or created display may include a color, a design, an image, a pattern, a slideshow, a video, media content or any other electronic visual display. In some embodiments, the user-selected or created display may include a specific color such as a PMS, Hex, CMYK, or RGB color, or any other color. In some embodiments, the user-selected or created display may include one or images such as a jpeg, bmp, eps, psd, git, pdt, raw, tiff image, and/or any other image format. In some embodiments, the user may select the view (e.g., landscape or portrait) for a display.

In some embodiments, the electronically customizable article may be configured to rotate a display on the electronic visual display based on the position of the electronically customizable article. For example, in some embodiments, the electronically customizable article may include an accelerometer and/or proximity sensors.

In some embodiments, the electronic visual display 210 may be in multiple locations on the electronically customizable article. In this way, the electronically customizable article may display multiple visual images on different parts of the electronically customizable article simultaneously. In some embodiments, the electronically customizable article may display a specified order and timing of images, display multiple visual images on different parts of the article, display stationary images or images in motion, designs, patterns and colors simultaneously. The electronically customizable article also may display a specified order and timing of images, colors, designs, patterns, or multiple visual images simultaneously or in synchronous with one or more other electronically customizable articles such as, for example, shoes and a belt.

In some embodiments, a time and/or date, email, or text message notification may be displayed on the electronic visual display. Display options also may consist of a user selected real time news feed, a social media feed, or other informative feeds such as stock market data.

In some embodiments, the electronically customizable article may display a media/video clip.

In some embodiments, the electronically customizable article may display video during real-time or near real-time video capture.

In some embodiments, the electronically customizable article may display live video images, still images, and video playback. In some embodiments, the electronically customizable article may include one or more built in cameras to capture and/or record the video or still images. In some embodiments, the camera may rotate via swivel, flip, pop-up, punch hole or any other style of camera. In some embodiments, the video or still images may be transferred to the electronically customizable article. In some embodiments, the electronically customizable article may include video-teleconferencing abilities including Skype, FaceTime and video chat capabilities.

In some embodiments, the electronically customizable article may display a specified order and timing of media/video clip images simultaneously or in synchronous with one or more other electronically customizable articles such as but not limited to shoes, belts and hats.

In some embodiments, the electronic visual display may include a backlight.

In some embodiments, the electronic visual display may be located on one or more sides of the electronically customizable article.

In some embodiments, the resolution and/or pixel definition and aspect ratio of the electronic visual display may be dependent on the size and style of electronically customizable article. In some embodiments, the electronic visual display may comprise 4K resolution, any other current, or any future developed resolution display capabilities.

In some embodiments, the electronic visual display and/or electronically customizable article may include glare and reflection reduction features.

In some embodiments, the electronically customizable article may include a multi-touch screen and/or handwriting recognition capabilities. In some embodiments, a wireless and/or Bluetooth functionality stylus may be utilized in display manipulation.

In some embodiments, the electronic visual display maybe placed in a locked position thereby disabling any accidental navigation while only displaying the user's desired image.

In some embodiments, the electronically customizable article may be used for advertisement purposes.

In some embodiments, the electronically customizable article may be configured to display notifications of calendar meetings and set alarms. In some embodiments, notifications may consist of a text display, image display, color illumination, an audio signal vibration, or a combination of the foregoing. In some embodiments, some fashion articles including but not limited to earrings, rings, bracelets, glasses, garments, and/or necklaces may utilize notifications such as vibration, color illuminations, an audio signal or a combination of, and/or other mentioned notifications to aid, for example, waking a user up from sleep, posture correction, and/or sedentary activity.

In some embodiments, patterns, designs, colors, images, media content along with other content may be ordered or downloaded to an electronically customizable article on a fee basis purchase using financial/accounting management systems allowing for financial arrangements and transactions such as a one-time fee, monthly fee and/or yearly subscriptions via computer and mobile applications, computer programs, internet websites and computer software. Some features maybe disabled such as the transfer of certain images, designs, patterns, colors and/or video content where fee purchase is required for download of material preventing unauthorized use of image content from designer, artist or creator of downloadable content or material.

In some embodiments, images, colors, designs, patterns and design templates maybe pre-downloaded, personally ordered via software or computer/mobile applications on a fee basis purpose to display on the electronically customizable article.

In some embodiments, the electronically customizable article may include built-in apps such as visual display touch-screen keyboard, time indicator with alarm, weather and calendar display, built in to do list and grocery manager app, drawing/note taking board and flashlight.

In some embodiments, the electronically customizable article may support and download various game systems e.g., Java games. In some implementation, the electronically customizable article may include pre-downloaded games.

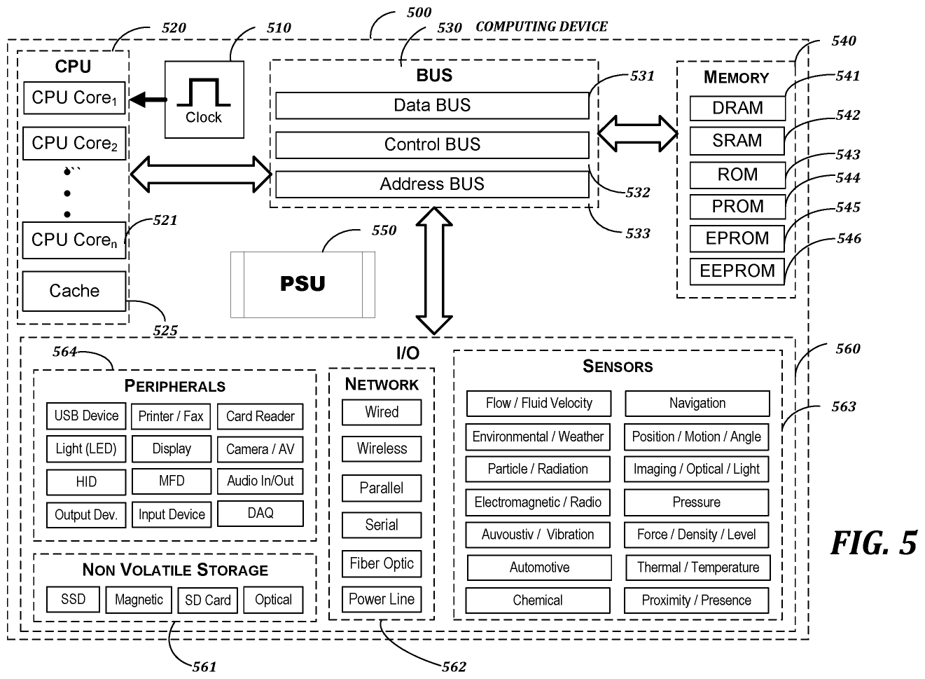

In some embodiments, the electronically customizable article may include wireless credit card features and terminals allowing for on-device purchasing of computer and software applications or other applications and programs, installation and updates. For instance, the electronically customizable article may comprise wireless features such as those illustrated in FIG. 5 and described below, including, but not limited to, NFC, RFID, and other near-field wireless communication technology. Moreover, the electronically customizable article may comprise RF protection technology, such as RFID blockers and the like.

In some embodiments, the electronically customizable article may include security features such as password requirements or biometric components to operate article or certain features of article to aid in protection of confidential information. In some embodiments, biometric sensor features such as voice/speech recognition may be utilized to help distinguish user's voice from all other external interferences or voices to execute voice commands or operate certain features of article. In some embodiments, biometric sensor features such as facial and/or voice/speech recognition features may be utilized to identify user and operate or carry out certain functions of the article. In some embodiments, biometric sensor features such as facial and/or voice/speech recognition features may be utilized to identify individuals who come in close proximity of article wherein the recognition may be pre-programmed, programmed from previous encounters or a collection of data from social media applications such as, but not limited to, Facebook, Instagram, and Twitter. In some embodiments, an image, video, text and/or audible sound may be displayed, or sound produced from article in association with the recognized individual. In some embodiments, other biometric features, components, or sensors such as fingerprint, voice/speech, facial, signature, physiological, behavioral, gait, and/or eyes/iris recognition may be utilized to identify, operate and carry out certain functions of the article. In some embodiments, fingerprint scanners may include, but not be limited to, capacitive, ultrasonic, in display and other future developed fingerprint scanners.

In some embodiments, the electronically customizable article may use computer, mobile or software applications in conjunction with features of the device such as a built in camera and video capture abilities to help color coordinate articles of clothing with the device by visual input from the camera of the device of colors, designs, images or patterns of a user's clothing which are then interpreted by the application into matching colors, designs, patterns or images that may then be displayed on unit by use of the application. In some embodiments, applications and/or algorithms may be used to match color, design, and/or pattern schemes in conjunction with sensory input or user input to assist in color coordinated fashion articles.

In some embodiments, the electronically customizable article is configured to connect with a mobile device via Bluetooth connectivity, for example, to display visual notification of incoming calls, text messages, calendar dates, email messages or voicemail messages. Further still, in some embodiments, wireless connectivity may be used for data and content transfer. By way of non-limiting example, Bluetooth connectivity may be used for image transfer.

In some embodiments, the electronically customizable article includes a GPS receiver for locating unit and navigation capabilities. The GPS receiver and transmitter may be used to track device if lost or stolen. In some embodiments, through the use of received location input data (Bluetooth, Wi-Fi and or GPS), computer, mobile applications, other wireless communication operating system and or other forms wireless communication and applications, selected retail information may be relayed to the electronically customizable article in visual and/or audible notifications of information such sales, coupons and rebates dependent on the location of the device in the vicinity of the retail store with received location data. In some embodiments visual retail information display notifications may consist of but not limited to previous liked retail items, retail preferences, coordinated retail items, matching retail items, present and future sales, special retail gifts etc. In some embodiments, a location sensory input data may manipulate display content such as a flashing light, brightening of displayed image, an illumination, and/or a stop sign image when location and GPS sensory data indicates a user is at a crosswalk, or crossing a street when walking, biking, or utilizing other modes of transportation.

In some embodiments, the electronically customizable article comprises E-Reader capabilities for E-Books, magazines, newspapers and other reading articles on a possible fee basis. Text and images may be displayed in formats such as, but not limited to or required to include PDF, TXT, CHM, DOC EXEL, EPUB, RTEF, and PUB. In some embodiments, the electronically customizable article may be configured to adjust the text size. In some embodiments, the electronically customizable article may be configured to vocalize the text via an audio narrator feature. In some embodiments, voice-to-text features may be utilized to display text on display screen to aid in communication, for example, the hearing impaired or language barriers. In some embodiments, language applications may be utilized to communicate when, for example, language barriers are present.

In some embodiments, the electronically customizable article may be powered by solar power or other sources of light kinetic energy sources, lithium ion, lithium ion polymer, nickel cadmium, fuel cell, Zinc air battery, nickel metal hydride battery, or a combination of the foregoing. The electronically customizable article may be recharged through USB to computer system, power adapter, wireless electricity, battery charger, battery charging pad, fast charging technology, or docking station. In some embodiments, the electronically customizable article may be configured to recharge other items through USB port or other port connectivity such as, for example, wireless charging.

In some embodiments, the electronically customizable article may be turned on or off and placed in different operating modes (e.g., air mode). In some embodiments, the electronically customizable article may be configured to display a default screen in certain modes. In some embodiments, the default screen may be the screen view when the display is turned off.

In some embodiments, the electronically customizable article may include battery conserving features including user operated dimming controls to control the amount of light emitted from unit and ambient light sensors with automatic dimming and brightening effects. In some embodiments, the electronically customizable article may be configured to have image display time minimums, which may vary according to specifics of displayed image, including image format and size. As a result, image display length ranges may vary depending on the electronic visual display. In some embodiments, the electronically customizable article may be configured to provide early notification of battery depletion with automatic display of default screen when battery is below a predetermined level.

In some embodiments, the electronically customizable article may be enclosed in an exterior protective transparent touch sensitive shell that is in the shape of the article that may be clear, transparent and/or translucent waterproof weatherproof flexible, shatterproof and/or scratch resistant. All parts of the article or portions of the article maybe covered with the protective exterior shell dependent on the size, shape and type of article. The exterior protective shell may consist of different types of material such as plastics. Different types of material or plastics may include PVC ABS, vinyt PES, PET, PE, PU, HDPE, LDPE, PP, PS, PC MF, PF, PEEK and/or silicone. In some embodiments, the exterior protective transparent touch sensitive shell may consist of alkali-aluminosilicate such as, but not limited to, gorilla glass, Dragontrail and xensation. In some embodiments, the electronic visual display may incorporate impact stabilizers to protect screen and/or electronic components. In some embodiments, the fashion article may incorporate emf radiation protection features.

In some embodiments, the exterior of the article may include additional features such as decorations, ornamentation and/or functional hardware features that maybe aesthetically appealing objects such as buttons, gems, jewels, zippers, belts, handles, straps, buckles, strings or laces, clasps, fasteners, closing devices, attachment devices, hinges, and other different types of hardware. In some embodiments, different texturized coverings may be added to some articles to help aid in the aesthetics of the article without hindering touch sensitive features or visibility of projected images. In some embodiments, hardware features may be added to the exterior of the article to aid in visual aesthetics or for functional purposes such as keeping device in an upright position, hanging position or viewing position or purpose. In some embodiments, functional hardware may also be used for purposes of docking the article to a docking station battery source if used or attaching device to a portable attachable keyboard that is either separate or may be combined with docking station to make use of the device as a laptop or personal computer format or position. In some embodiments, functional hardware features maybe added to article to aid in functional purposes such as a stand or kick stand located in the back of a tie or bottom of a purse to help keep the fashion article in an upright position for easy viewing or touchscreen display manipulation. In some embodiments, hardware and functional features like fasteners and clasp maybe added to fashion articles such as a tie to detach and attach the bar portion of the tie from the neck portion of the tie allowing for example the fashion article to multifunction as a bow tie, neck tie and/or a tie. In some embodiments, the fashion article may utilize a wired or wireless docking station. In some embodiments, the fashion article may connect to an electronic, wireless and/or projected keyboard and/or mouse to function as a laptop or personal computer format. For example, a user may place an electronic handbag or tie on a desk in an upright position and connect to a for mentioned keyboard and/or mouse allowing the articles screen to be utilized and function as a laptop or personal computer. In some embodiments, the wireless projected keyboard and mouse ability may be incorporated in the fashion article.

In some embodiments, the electronically customizable article may include audio system components such as built in audio speakers, headphone port and microphone with voice recording abilities, input and output voice command abilities to process, interpret and functionalize sound, speaker phone and playback ability. In some embodiments, the electronically customizable article may be configured to download music content via applications. In some embodiments, voice command words may be customized and programmed by user to carry out certain functions and operations of fashion article. In some embodiments, biometric sensor features such as voice/speech recognition may be utilized to help distinguish user's voice from all other external interferences or voices to execute voice commands or operate certain features of article. In some embodiments, certain fashion articles such as earrings may incorporate a microphone. In some embodiments, the fashion articles incorporating a microphone may function as wireless such as Bluetooth headphones/earpiece, whereas the earring portion of device may fasten to earlobe and the earbud/earpiece portion may hang from earring. In some embodiments, the earing may comprise a dangle earring, fasten to exterior portion of ear and/or fasten to earring with a fastening device including, but not limited to, a magnet or clip as a fashion statement. The User may then place earbuds/earphone near or in ear canal to listen to music and/or engage in a phone conversation with integrated microphone via wireless communication with another computing device for example, but not limited to, a mobile phone. In some embodiments, the electronical customizable earring may incorporate sensors to determine user's heart rate, o2 saturation, body temperature and/or other physiological data.

In some embodiments, the electronically customizable article may include an audible alarm system that may be activated by user in potentially threatening events.

In some embodiments, the electronically customizable article may be configured to play and display various music systems e.g., mp3 player or media player.

In some embodiments, the electronically customizable article may include incorporate sound sensors that may activate visual simulation of displayed images or colors with sound e.g., displayed color changes with received sound frequencies.

In some embodiments, the electronically customizable article may serve as an alert system for incoming calls, text messages, emails, calendar events, alarm clock alerts, traffic alerts, car and home alarm system alerts and other alerts.

In some embodiments, the electronically customizable article may comprise one or more of the following features: fingerprint scanners or other biometric techniques (for purses, wallets, suitcases etc.), audio panic alarms, sensor activated interior color illuminations (for purses, bags, backpacks etc.), touchscreen security code options to open, close or operate articles, automatic closing apparatus (for purses, backpacks, laptop bags etc.), integrated hanging apparatus (e.g., purses), elongating or retractable adjustable straps (e.g., purses, laptop bags and backpacks), Integrated image projectors (e.g., briefcase and phones), adjustable components of articles (e.g., the height or heel of shoe or ability to convert style of shoe from e.g., open toe or closed toe), cooling and warming material features on select articles(e.g., shoes), motion sensors with visual pulse, pedometer and estimated calorie burner display on shoes with information recording ability, adjustable cushioning in shoes to aid in comfort removable/interchangeable customizing handles and inner material lining for (e.g., purses). In some embodiments, the electronically customizable article may incorporate electronic textile mechanisms. In some embodiments, some fashion articles may incorporate VR and AR technology for example glasses. In some embodiments, the electronically customizable fashion article may incorporate environmental, physiological and biometric sensors to alert, notify, record and/or manipulate display content based on received sensory data. Certain fashion articles may include physiological and/or biometric sensors to detect body temperature, basal body heat to aid in other detection such as ovulation cycle, pulse, O2 saturation, blood pressure, pedometer, hydration/skin hydration, fat percentage/body mass index and/or other sensory data information. In some embodiments, certain fashion articles may include environmental sensors to detect data including but not limited to external temperature, air quality, air allergens, air-based toxins/pollution (ex. Nitrogen, carbon monoxide, carbon dioxide and/or asbestos) and/or humidity. In some embodiments, based on received sensory data such as temperature and/or user preference, the electronically customizable article may incorporate heating and cooling mechanisms. In some embodiments, the fashion article such as a bracelet or ring may incorporate identification and notification of proper chest compression depth, chest recoil and or oxygenation readings based on sensor data in the event of user performing CPR.

In some embodiments, based on the fashion article's location, as determined by, for example, various electronic components within the fashion articles, the fashion article's visual display can be manipulated to display data associated with the received location information. In some embodiments, the fashion article's received location information can be used in conjunction with calendar events such as, but not limited to, appointments, meetings, networking event, concerts, festivals, events, parties, concerts, organizers and or social media events, and data retrieved therefrom, to manipulate visual display content.

The instructions and processing for such function may be performed locally by the computing device associated with the fashion article. In other embodiments, the instructions and processing for such function may be performed by a remote computing device in operative communication with the fashion article's computing device. Yet, further still, in some embodiments, processing for such function may be performed partially on the local computing device and a remote computing device.

In accordance to embodiments of the present disclosure, such processing may receive the necessary access to such calendar events associated with a user of the fashion article. In this way, the computing device(s) will have sufficient access to all necessary data associated with the user and an event. Accordingly, the fashion article may be configured to constantly detect the user's location and cross-reference various location and event-based databases (either associated with the user or not associate with the user). The fashion article may then be configured to determine which content to display and retrieve said content for display. In some embodiments, the determination of which content to display may be performed by, for example, instructions received from a centralized server in connection with the fashion article and the various location and event databases. The centralized server may be tied to, for example, but not limited to, and end-user application through which the user may communicate a set of rules and instructions for displaying content on the fashion article's display.

By way of non-limiting example, the user may have an identified calendar event of a ball game (and provided details associated therewith) at a certain time, date and location. The user wearing the fashion article may arrive at the identified location such as a stadium. Upon detection of the user's location, the fashion article can utilize location input data and calendar event data to determine which content to display, or how to manipulate the visual display to display. The displayed data associated with event may comprise, for example, but not limited to, the sports team logo or colors associated with sports team.

The manipulated visual content that is displayed based on location input data and calendar event data can be programmed, pre-programmed, user created, downloaded, data transferred and or received via internet. The same visual display manipulation can occur with events such as but not limited to birthday parties, graduations, anniversary parties, weddings, baby showers, business meetings, doctor appointments and any other events, celebratory events, festivals or meetings.

By way of another non-limiting example, a user wearing a fashion article consistent with an embodiment of the present disclosure may arrive at a business networking event. Location input data and calendar event data can be utilized to manipulate the visual display content to display data associated with the event such as a greeting with user's name (e.g., “Hi, my name is Renee”), company name, company logo, company information, an inviting message/greeting, and or other business networking information or a combination of thereof.

In some embodiments, location input data can also be utilized to manipulate display content when user wearing fashion article arrives at certain locations such as the grocery store and grocery store list automatically populates on display screen. Location input data in conjunction with calendar event data such as doctor's appointment as well as biologic/environment sensor data can be utilized to manipulate display content in displaying biologic/environment data such as but not limited to heart rate, blood pressure, temperature, oxygen saturation, and the like. In this way, when fashion article detects user to be at doctor's office based on received sensor data from location and calendar event. This displayed information may in turn be used by a medical provider.

In some embodiments, the fashion article can utilize received location input data to automatically manipulate visual display content in reducing lighting and or visual content features to reduce visual distraction when fashion article is detected to be at certain locations such as movie theaters, libraries, schools, doctors office, and the like, or programmed locations such as work, business meetings, and the like. In some embodiments, audio data can be utilized in conjunction with location data to automatically reduce emitted sound or place sound on silence or vibration status when fashion article's location sensors detect fashion article to be at locations such as movie theaters, libraries, doctors office, spiritual organizations, work, schools, and the like.

In various embodiments, based on visual data received from a camera associated with the fashion article, the visual display content can be manipulated to display colors, patterns, video data, design, and images that mirror, mimic or have a chameleon like effect of the surrounding environment of the fashion article. These images, designs, patterns, video data and colors can be and maybe further manipulated until desired visual content is achieved. Visual sensors located in the fashion article can be used to detect colors, designs, patterns, video and images of elements in the surrounding environment. This data can be used, in turn, to manipulate the visual content displayed by the fashion article.

In some embodiments, the visual display content can be manipulated based on the received selected input visual data from the camera. The selected input visual data can be a color, design, pattern, video or image located in the surrounding environment of the article which can then be displayed on the visual display of the fashion article. In some implementations the manipulated visual display content can be further manipulated to display user desired visual content. By way of non-limiting example, a user wearing a fashion article can utilize visual input data from the camera of a selected object located in the environment such as the color of a friend's clothing article. The electronic fashion article can then display the exact color of the received data on the visual display of fashion article to match the friend's article of clothing color.

Still consistent with embodiments of the present disclosure, the fashion article's sound sensors can be utilized to receive sound input. The sound input may be processed in order to determine a modification of audio output settings and/or visual display manipulation. That is, sound sensors located in fashion article can be utilized to interpret and identify certain sounds and manipulate visual display content based on the sound received from the environment.

The instructions and processing for such function may be performed locally by the computing device associated with the fashion article. In other embodiments, the instructions and processing for such function may be performed by a remote computing device in operative communication with the fashion article's computing device. Yet, further still, in some embodiments, processing for such function may be performed partially on the local computing device and a remote computing device.

In accordance to embodiments of the present disclosure, such audio-based processing may receive the necessary access to external databases as needed associated with a user of the fashion article. In this way, the computing device(s) will have sufficient access to all necessary data associated with the user and an event. Accordingly, the fashion article may be configured to constantly detect the user's audio-environment and cross-reference various databases (either associated with the user or not associate with the user). The fashion article may then be configured to determine which content to display and retrieve said content for display. In some embodiments, the determination of which content to display, or how to manipulate the content displayed, may be performed by, for example, instructions received from a centralized server in connection with the fashion article and the various location and event databases. The centralized server may be tied to, for example, but not limited to, and end-user application through which the user may communicate a set of rules and instructions for displaying content on the fashion article's display.

By way of non-limiting example, if user wearing a fashion article is at a sporting event and the user's supporting team scores points and the user and crowd around user cheers.

The sound sensor can interpret received sound data from the environment along with identify user's voice and manipulate visual display content such as displaying “Go Team” or other text or graphics to display on article based on received data. In some implementations location data can be utilized in conjunction with sound sensors to manipulate display content.

In some embodiments, sound sensors can detect, interpret and identify certain sounds such as, but not limited to, music and identify the song and/or music artist associated with the song based on the received sound data. The fashion article display content can then be manipulated to display visual content associated with data received from sound sensor, the manipulated visual content can consist of but not limited to music lyrics, music videos, artist image and or other data, text, or graphics associated with music.

In some embodiments, sound sensor data can be used to manipulate visual display content such as displaying user's selected images such as an animated character that dances or moves in conjunction with the received sound data.

In some embodiments, sound sensors can detect, distinguish and identify certain identifiable programmed voices that are received in close proximity of fashion articles environment. The fashion article can then manipulate visual content based on received sound data. The manipulated data can consist of but not limited to display images such as text data “Hi Yuri” along with images, colors, designs or video data associated with received sound sensor data.

By way of non-limiting example, if a user wearing the fashion article is at an event where the sound sensor receives input data from the environment that the sound sensor interprets it to be a loud environment, based off of the received sound data the article can then manipulate the audio output data by increasing sound projection to aid in alerting user of incoming notifications or other audio data. Similar implementations can be utilized to interpret input sound data from the sound sensor of a quiet or reduced noise environment. Based off the received input sound data from the sound sensor the fashion article can then manipulate the output audio data in decreasing sound projection by reducing, silencing or vibrating sound alerts, sound data and sound notification. In some embodiments other fashion article features such as location input data and biologic/environment sensor data can be used in conjunction with sound sensor to manipulate audio output data. This feature can be beneficial in certain situations such as but not limited to the fashion article being in close proximity to a baby's/children room or user maybe holding baby/children while wearing fashion article and baby/children maybe sleeping. These same technologies and techniques can be or maybe implemented on any fashion article or any other electronic device or application.

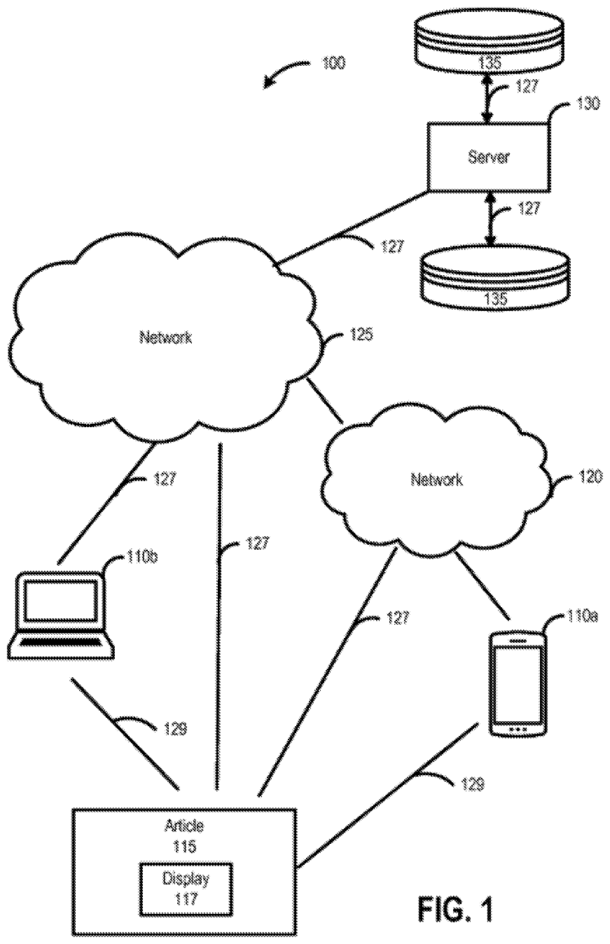

FIG. 1 illustrates an example environment 100 of the present disclosure for setting or changing the outer appearance of an electronically customizable article. As shown in FIG. 1, the environment 100 may include client devices 110a and 110b (collectively client device 110), an electronically customizable article 115 with display 117, a wireless cellular network 120, network 125, a server 130, and a data storage 135.

Client devices 110a and 110b are depicted as a mobile phone 110a and desktop computer 110b, respectively, but client devices 110 may comprise any type of computing device, such as a desktop computer system, a laptop, a smartphone, a mobile telephone, a tablet-style computer, or any other handheld electronic device.

In some embodiments, the client device 110a or the electronically customizable article 115 may connect to the network 125 through a wireless cellular network 120, such as GPRS-based and CDMA-based wireless networks, as well as 802.16 WiMax and long-range wireless data networks.

The network 125 may be an intranet and extranet a virtual private network (VPN), a local area network (LAN), a wireless LAN (WLAN), a wide area network (WAN), a metropolitan area network (MAN), a portion of the Internet or another network 125 or a combination of two or more such networks. The present disclosure contemplates any suitable network 125.

One or more links 127 couple an electronically customizable article 115, a server 130, or a client 110b to network 125. In some embodiments, one or more links 127 each may include one or more wired, wireless, or optical links. In some embodiments, one or more links 127 each may include an intranet and extranet a VPN, a LAN, a WLAN, a WAN, a MAN, a portion of the Internet or another link or a combination of two or more such links. The present disclosure contemplates any suitable links 127 coupling electronically customizable article 115, servers 130 and clients 110b to network 125. One or more links 129 couple an electronically customizable article 115 to a client 110. In some embodiments, one or more links 129 each may include one or more wired, wireless, or optical links. In some embodiments, one or more links 129 each may include an intranet and extranet a WI-Fl network, a wireless cellular network, a Wi-Max network, a long-range wireless data network, an ad hoc network, a personal area network (PAN) (such as BLUETOOTH), a VPN, a LAN, a WLAN, a WAN, a MAN, a portion of the Internet or another link or a combination of two or more such links. In some embodiments, links 129 may include cable or connectors (e.g., USB cables) or a storage medium such as a flash drive, memory card, or other data storage device. The present disclosure contemplates any suitable links 129 coupling electronically customizable article 115 to clients 110.

Client devices 110a, 110b and the electronically customizable article 115 may interact with the server 130 via an application, such as a web browser or a native application including a mobile application, residing on the client devices 110a, 110b and electronically customizable article 115 to create, download, order, or configure images (stilt video, graphic, or any other display item) to display on the electronically customizable article 115. In some embodiments, the server 130 may be a social media site, such as Twitter, an e-mail server, other social-networking websites, shopping sites, review sites, and any third-party website to interact with content or other users. This disclosure contemplates any type of server 130 connected to network 125. In some embodiments, the electronically customizable fashion article may carry out the function of different application.

In some embodiments, server 130 may be a unitary server or may be a distributed server spanning multiple computers or multiple datacenters. Server 130 may be of various types, such as, for example and without limitation, web server, news server, mail server, message server, advertising server, file server, application server, exchange server, database server, or proxy server. In some embodiments, Server 130 may include hardware, software, or embedded logic components or a combination of two or more such components for carrying out the appropriate functionalities implemented or supported by Server 130. For example, a web server is generally capable of hosting websites containing web pages or particular elements of web pages. More specifically, a web server may host HTML files or other file types, or may dynamically create or constitute files upon a request and communicate them to clients 110 in response to HTTP or other requests from clients 110. A mail server is generally capable of providing electronic mail services to various clients 110. A database server is generally capable of providing an interface for managing data stored in one or more data stores.

In some embodiments, one or more data storages 135 may be communicatively linked to server 130 via one or more links 127. In some embodiments, data storages 135 may be used to store various types of information. In some embodiments, the information stored in data storages 135 may be organized according to specific data structures. In particular embodiments, each data storage 135 may be a relational database. Particular embodiments may provide interfaces that enable server 130 or clients 110 to manage, e.g., retrieve, modify, add, or delete, the information stored in data storage 135.

Client devices 110a, 110b and the electronically customizable article 115 may interact with each other via an application residing on the client devices 110a, 110b and electronically customizable article 115 to create, download, or configure images (stilt video, graphic, or any other display item) to display on the electronically customizable article 115.

In some embodiments, each client 110 may be an electronic device including hardware, software, or embedded logic components or a combination of two or more such components and capable of carrying out the appropriate functions implemented or supported by client 110. For example, and without limitation, a client 110b may be any type of computing device such as a desktop computer system, a laptop, a smartphone, a mobile telephone, a tablet-style computer, or any other handheld electronic device. Client 110 may be configured to carry out the function of a computing device such as a laptop, a smartphone, a mobile telephone, a tablet-style computer, or any other handheld electronic device. The present disclosure contemplates any suitable clients 110. A client 110 may enable a network user at client 110 to access network 127. A client 110 may enable its user to communicate with other users at other clients 110.

A client 110 may have a web browser, such as MICROSOFT INTERNET EXPLORER, GOOGLE CHROME, MOZILLA FIREFOX, or any other future developed web browser and may have one or more add-ons, plug-ins, or other extensions. A user at client 110 may enter a Uniform Resource Locator (URL) or other address directing the web browser to a server 130, and the web browser may generate a Hyper Text Transfer Protocol (HTTP) request and communicate the HTTP request to server 130. Server 130 may accept the HTTP request and communicate to client 110 one or more Hyper Text Markup Language (HTML) files responsive to the HTTP request. Client 110,115 may render a web page based on the HTML files from server 130 for presentation to the user. The present disclosure contemplates any suitable web page files. As an example and not by way of limitation, web pages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a web page encompasses one or more corresponding web page files (which a browser may use to render the web page) and vice versa, where appropriate.

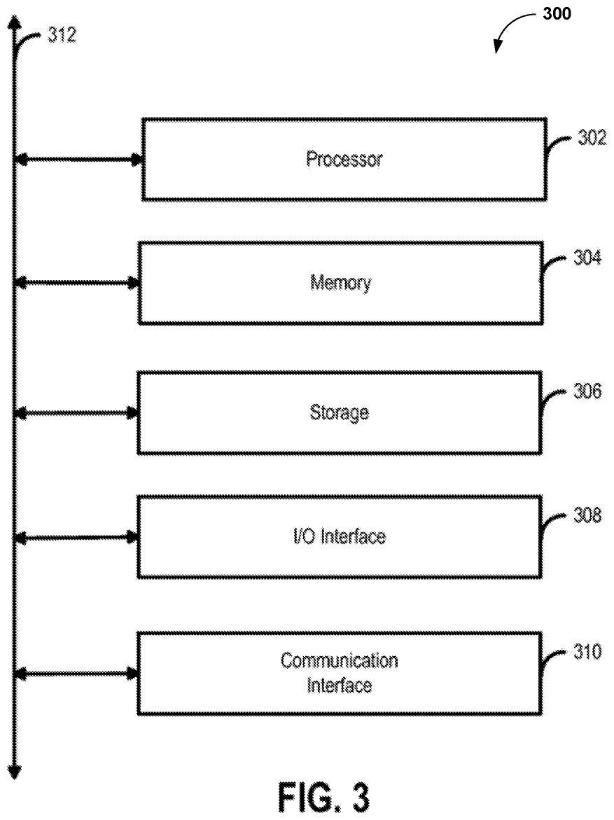

FIG. 3 illustrates an example computer system 300, which may be used with some embodiments of the present invention. FIG. 3 illustrates an example computer system for a client device or electronically customizable article. This disclosure contemplates any suitable number of computer systems 300. This disclosure contemplates computer system 300 taking any suitable physical form. As example and not by way of limitation, computer system 300 may be an embedded computer system, a system-on-chip (SOC), a single-board computer system (SBC) (such as, for example, a computer-on-module (COM) or system-on-module (SOM)), a desktop computer system, a laptop, an interactive kiosk, a mainframe, a mesh of computer systems, a mobile telephone, a personal digital assistant (PDA), a server, or a combination of two or more of these. Where appropriate, computer system 300 may include one or more computer systems 300; be unitary or distributed; span multiple locations; span multiple machines; or reside in a cloud, which may include one or more cloud components in one or more networks. Where appropriate, one or more computer systems 300 may perform without substantial spatial or temporal limitation one or more steps of one or more methods described or illustrated herein. As an example and not by way of limitation, one or more computer systems 300 may perform in real time or in batch mode one or more steps of one or more methods described or illustrated herein. One or more computer systems 300 may perform at different times or at different locations one or more steps of one or more methods described or illustrated herein, where appropriate.

In some embodiments, computer system 300 includes a processor 302, memory 304, storage 306, an input/output (I/O) interface 308, a communication interface 310, and a bus 312. Although this disclosure describes and illustrates a particular computer system having a particular number of particular components in a particular arrangement this disclosure contemplates any suitable computer system having any suitable number of any suitable components in any suitable arrangement.

In some embodiments, processor 302 includes hardware for executing instructions, such as those making up a computer program. As an example and not by way of limitation, to execute instructions, processor 302 may retrieve (or fetch) the instructions from an internal register, an internal cache, memory 304, or storage 306; decode and execute them;

and then write one or more results to an internal register, an internal cache, memory 304, or storage 306. In some embodiments, processor 302 may include one or more internal caches for data, instructions, or addresses. The present disclosure contemplates processor 302 including any suitable number of any suitable internal caches, where appropriate. As an example and not by way of limitation, processor 302 may include one or more instruction caches, one or more data caches, and one or more translation look-aside buffers (TLBs). Instructions in the instruction caches may be copies of instructions in memory 304 or storage 306, and the instruction caches may speed up retrieval of those instructions by processor 302. Data in the data caches may be copies of data in memory 304 or storage 306 for instructions executing at processor 302 to operate on; the results of previous instructions executed at processor 302 for access by subsequent instructions executing at processor 302 or for writing to memory 304 or storage 306; or other suitable data. The data caches may speed up read or write operations by processor 302. The TLBs may speed up virtual-address translation for processor 302. In some embodiments, processor 302 may include one or more internal registers for data, instructions, or addresses. The present disclosure contemplates processor 302 including any suitable number of any suitable internal registers, where appropriate. Where appropriate, processor 302 may include one or more arithmetic logic units (ALUs); be a multi-core processor; or include one or more processors 302. Although this disclosure describes and illustrates a particular processor, this disclosure contemplates any suitable processor. In some embodiments, the electronically customizable article may include, but not limited to, microprocessors, for example, snapdragon or any other future developed processor.

In some embodiments, memory 304 includes main memory for storing instructions for processor 302 to execute or data for processor 302 to operate on. As an example and not by way of limitation, computer system 300 may load instructions from storage 306 or another source (such as, for example, another computer system 300) to memory 304. Processor 302 may then load the instructions from memory 304 to an internal register or internal cache. To execute the instructions, processor 302 may retrieve the instructions from the internal register or internal cache and decode them. During or after execution of the instructions, processor 302 may write one or more results (which may be intermediate or final results) to the internal register or internal cache. Processor 302 may then write one or more of those results to memory 304. In some embodiments, processor 302 executes only instructions in one or more internal registers or internal caches or in memory 304 (as opposed to storage 306 or elsewhere) and operates only on data in one or more internal registers or internal caches or in memory 304 (as opposed to storage 306 or elsewhere). One or more memory buses (which may each include an address bus and a data bus) may couple processor 302 to memory 304. Bus 312 may include one or more memory buses, as described below. In some embodiments, one or more memory management units (MMUs) reside between processor 302 and memory 304 and facilitate accesses to memory 304 requested by processor 302. In some embodiments, memory 304 includes random access memory (RAM). This RAM may be volatile memory, where appropriate, this RAM may be dynamic RAM (DRAM) or static RAM (SRAM). Moreover, where appropriate, this RAM may be single-ported or multi-ported RAM.

The present disclosure contemplates any suitable RAM. Memory 304 may include one or more memories 302, where appropriate. Although this disclosure describes and illustrates particular memory, this disclosure contemplates any suitable memory.

In some embodiments, storage 306 includes mass storage for data or instructions. As an example and not by way of limitation, storage 306 may include an HDD, a floppy disk drive, flash memory, an optical disc, a magneto-optical disc, magnetic tape, or a Universal Serial Bus (USB) drive or a combination of two or more of these. Storage 306 may include removable or non-removable (or fixed) media, where appropriate. Storage 306 may be internal or external to computer system 300, where appropriate. In some embodiments, storage 306 is non-volatile, solid-state memory. In some embodiments, storage 306 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 306 taking any suitable physical form. Storage 306 may include one or more storage control units facilitating communication between processor 302 and storage 306, where appropriate. Where appropriate, storage 306 may include one or more storages 306. Although this disclosure describes and illustrates particular storage, this disclosure contemplates any suitable storage.

In some embodiments, I/O interface 308 includes hardware, software, or both providing one or more interfaces for communication between computer system 300 and one or more I/O devices. Computer system 300 may include one or more of these I/O devices, where appropriate. One or more of these I/O devices may enable communication between a person and computer system 300. As an example and not by way of limitation, an I/O device may include a keyboard, keypad, microphone, monitor, mouse, printer, scanner, speaker, still camera, stylus, tablet touch screen, trackball, video camera, another suitable I/O device or a combination of two or more of these. In some embodiments, another fashion article may be in communication and co-operation with another fashion article. In this way, and in some implementations, the first fashion article might mirror, control, or otherwise be associated with the operation of a second fashion article. An I/O device may include one or more sensors. This disclosure contemplates any suitable I/O devices and any suitable I/O interfaces 308 for them. Where appropriate, I/O interface 308 may include one or more device or software drivers enabling processor 302 to drive one or more of these I/O devices. I/O interface 308 may include one or more I/O interfaces 308, where appropriate. Although this disclosure describes and illustrates a particular I/O interface, this disclosure contemplates any suitable I/O interface.

In some embodiments, communication interface 310 includes hardware, software, or both providing one or more interfaces for communication (such as, for example, packet-based communication) between computer system 300 and one or more other computer systems 300 or one or more networks. As an example and not by way of limitation, communication interface 310 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 310 for it. As an example and not by way of limitation, computer system 300 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 300 may communicate with a wireless PAN (WPAN) (such as, for example, a BLUETOOTH WPAN), a WI-Fl network, a WI-MAX network, a cellular telephone network (such as, for example, a Global System for Mobile Communications (GSM) network), GPS, or other suitable wireless network or a combination of two or more of these. Computer system 300 may include any suitable communication interface 310 for any of these networks, where appropriate. Communication interface 310 may include one or more communication interfaces 310, where appropriate. Although this disclosure describes and illustrates a particular communication interface, this disclosure contemplates any suitable communication interface.

In some embodiments, bus 312 includes hardware, software, or both coupling components of computer system 300 to each other. As an example and not by way of limitation, bus 312 may include an Accelerated Graphics Port (AGP) or other graphics bus, an Enhanced Industry Standard Architecture (EISA) bus, a front-side bus (FSB), a HYPERTRANSPORT (HT) interconnect an Industry Standard Architecture (ISA) bus, an INFINIBAND interconnect a low-pin-count (LPC) bus, a memory bus, a Micro Channel Architecture (MCA) bus, a Peripheral Component Interconnect (PCI) bus, a PCI-Express (PCI-X) bus, a serial advanced technology attachment (SATA) bus, a Video Electronics Standards Association local (VLB) bus, or another suitable bus or a combination of two or more of these. Bus 312 may include one or more buses 312, where appropriate. Although this disclosure describes and illustrates a particular bus, this disclosure contemplates any suitable bus or interconnect.

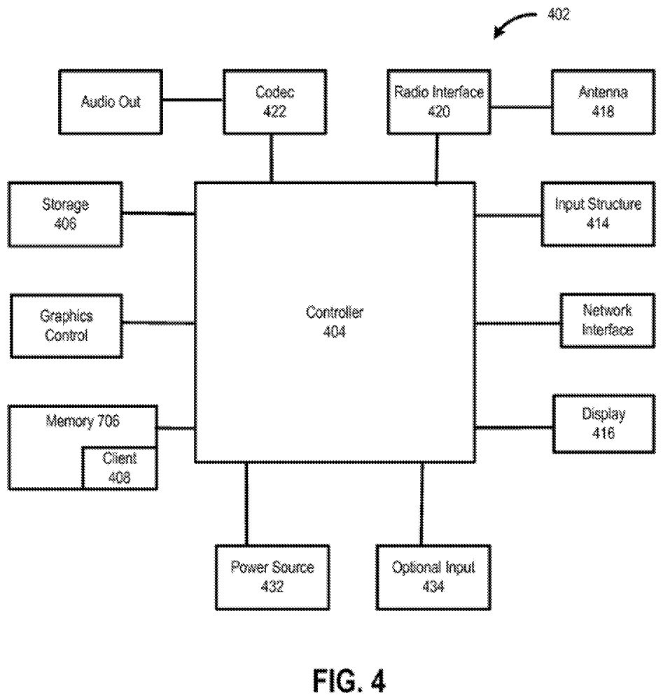

The client-side functionality described above may be implemented as a series of instructions stored on a computer-readable storage medium that when executed, cause a programmable processor to implement the operations described above. While the client devices 110 may be implemented in a variety of different hardware and computing systems, FIG. 4 shows a schematic representation of the main components of an example computing platform 402, according to various particular embodiments. Multipoint sensing devices generally include a controller 404 which may comprise a microcontroller or one or more processors configured to execute instructions and to carry out operations associated with a computing platform. In various embodiments, controller 404 may be implemented as a single-chip, multiple chips and/or other electrical components including one or more integrated circuits and printed circuit boards. Controller 404 may optionally contain a cache memory unit for temporary local storage of instructions, data, or computer addresses. By way of example, using instructions retrieved from memory, controller 404 may control the reception and manipulation of input and output data between components of computing platform 402. In some embodiments, the electronically customizable fashion article may include Al chips to allow for artificial intelligence applications.

Controller 404 together with a suitable operating system may operate to execute instructions in the form of computer code and produce and use data. By way of example and not by way of limitation, the operating system may be Windows-based, Mac-based, or Unix or Linux-based, or Symbian-based, among other suitable operating systems. The operating system, other computer code (including control client 408 described below) and/or data may be physically stored within a memory block 406 that is operatively coupled to controller 404.

Memory block 406 encompasses one or more storage media and generally provides a place to store computer code (e.g., software and/or firmware) and data that are used by the computing platform 402. By way of example, memory block 406 may include various tangible computer-readable storage media including Read-Only Memory (ROM) and/or Random-Access Memory (RAM). As is well known in the art ROM acts to transfer data and instructions uni-directionally to controller 404, and RAM is used typically to transfer data and instructions in a bi-directional manner. Memory block 406 may also include one or more fixed storage devices in the form of by way of example, solid-state hard disk drives (HDDs), among other suitable forms of memory coupled bi-directionally to controller 404. Information may also reside on a removable storage medium loaded into or installed in multipoint sensing devices when needed. By way of example, any of a number of suitable memory cards may be loaded into computing platform 402 on a temporary or permanent basis.

Controller 404 is also generally coupled to a variety of interfaces such as graphics control video interface, input interface, output interface, and storage interface, and network interface, and these interfaces in turn are coupled to the appropriate devices. In certain embodiments, controller 404 may connected to an input structure 414 and display 416 may be provided together, such an in the case of a touchscreen where a touch sensitive mechanism is provided in conjunction with the display 416. In such embodiments, the user may select or interact with displayed interface elements via the touch sensitive mechanism. In this way, the displayed interface may provide interactive functionality, allowing a user to navigate the displayed interface by touching the display 416.

Controller 404 may receive instruction signals from input structure 414 and control the operation of display 416. By way of example, display 416 may incorporate liquid crystal display (LCD), light emitting diode (LED), Interferometric modulator display (IMOD), or any other suitable display technology. Audio signals may be transmitted and received by means of an antenna 418 that may be connected through a radio interface 420 or audio input interface such as microphone to codec 422 configured to process signals under control of controller 404. Additionally, multipoint sensing devices may be powered power source 432.

Client devices 110 may also include one or more user input devices 434 (other than input structure 414) that are operatively coupled to the controller 404. Generally, input devices 434 are configured to transfer data, commands and responses from the outside world into multipoint sensing devices. By way of example, client devices 110 may include a keyboard or mouse. Input devices 434 may also include one or more hard buttons.

Display device 416 is generally configured to display a graphical user interface (GUI) that provides an easy to use visual interface between a user of the computing platform 402 and the operating system or application(s) running on the client devices 110. Generally, the GUI presents programs, files and operational options with graphical images. During operation, the user may select and activate various graphical images displayed on the display 416 in order to initiate functions and tasks associated therewith.

Herein, reference to a computer-readable storage medium encompasses one or more non-transitory, tangible computer-readable storage media possessing structure. As an example and not by way of limitation, a computer-readable storage medium may include a semiconductor-based or other integrated circuit (IC) (such, as for example, a field-programmable gate array (FPGA) or an application-specific IC (ASIC)), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. Herein, reference to a computer-readable storage medium excludes any medium that is not eligible for patent protection under 35 U.S.C. § 101. Herein, reference to a computer-readable storage medium excludes transitory forms of signal transmission (such as a propagating electrical or electromagnetic signal per se) to the extent that they are not eligible for patent protection under 35 U.S.C. § 101.

This disclosure contemplates one or more computer-readable storage media implementing any suitable storage. In some embodiments, a computer-readable storage medium implements one or more portions of processor 302 (such as, for example, one or more internal registers or caches), one or more portions of memory 304, one or more portions of storage 306, or a combination of these, where appropriate. In some embodiments, a computer-readable storage medium implements RAM or ROM. In some embodiments, a computer-readable storage medium implements volatile or persistent memory. In some embodiments, one or more computer-readable storage media embody software. Herein, reference to software may encompass one or more applications, bytecode, one or more computer programs, one or more executables, one or more instructions, logic, machine code, one or more scripts, or source code, and vice versa, where appropriate. In some embodiments, software includes one or more application programming interfaces (APis). This disclosure contemplates any suitable software written or otherwise expressed in any suitable programming language or combination of programming languages. In some embodiments, software is expressed as source code or object code. In some embodiments, software is expressed in a higher-level programming language, such as, for example, C Pert or a suitable extension thereof. In some embodiments, software is expressed in a lower-level programming language, such as assembly language (or machine code). In some embodiments, software is expressed in JAVA.

In some embodiments, software is expressed in Hyper Text Markup Language (HTML), Extensible Markup Language (XML), or other suitable markup language. The present disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend.

The foregoing description of the embodiments of the invention has been presented for the purpose of illustration; it is not intended to be exhaustive or to limit the invention to the precise forms disclosed. Persons skilled in the relevant art may appreciate that many modifications and variations are possible in light of the above disclosure. For example, although the foregoing embodiments have been described in the context of a social network system, it will apparent to one of ordinary skill in the art that the invention may be used with any electronic social network service and, even if it is not provided through a website. Any computer-based system that provides social networking functionality may be used in accordance with the present invention even if it relies, for example, on e-mail, instant messaging or other form of peer-to-peer communications, and any other technique for communicating between users. The invention is thus not limited to any particular type of communication system, network, protocol format or application.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment a software module is implemented with a computer program product comprising a computer-readable medium containing computer program code, which may be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium or any type of media suitable for storing electronic instructions and coupled to a computer system bus. Furthermore, any computing systems referred to in the specification may include a single processor or may be architectures employing multiple processor designs for increased computing capability.

While the foregoing processes and mechanisms may be implemented by a wide variety of physical systems and in a wide variety of network and computing environments, the server or computing systems described below provide example computing system architectures for didactic, rather than limiting, purposes.

The present invention has been explained with reference to specific embodiments. For example, while embodiments of the present invention have been described as operating in connection with a social network system, the present invention may be used in connection with any communications facility that allows for communication of messages between users, such as an email hosting site. Other embodiments will be evident to those of ordinary skill in the art. It is therefore not intended that the present invention be limited, except as indicated by the appended claims.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

Various computing aspects disclosed herein, such as, but not limited to, the electronically customizable article, may comprise or be embodied as a computing device 500. The computing device 500 may comprise, but not be limited to the following:
Mobile computing device, such as, but is not limited to, a laptop, a tablet, a smartphone, a drone, a wearable, an embedded device, a handheld device, an Arduino, an industrial device, or a remotely operable recording device;
A supercomputer, an exa-scale supercomputer, a mainframe, or a quantum computer;
A minicomputer, wherein the minicomputer computing device comprises, but is not limited to, an IBM AS400/iSeries/System I, A DEC VAX/PDP, a HP3000, a Honeywell-Bull DPS, a Texas Instruments TI-990, or a Wang Laboratories VS Series;
A microcomputer, wherein the microcomputer computing device comprises, but is not limited to, a server, wherein a server may be rack mounted, a workstation, an industrial device, a raspberry pi, a desktop, or an embedded device;

The platform as embodied in FIG. 2 may be hosted on a centralized server or a cloud computing service. Although the plurality of methods has been described to be performed by a computing device 500, it should be understood that, in some embodiments, different operations may be performed by a plurality of the computing devices 500 in operative communication over one or more networks.

Embodiments of the present disclosure may comprise a system having a central processing unit (CPU) 520, a bus 530, a memory unit 540, a power supply unit (PSU) 550, and one or more Input/Output (I/O) units. The CPU 520 coupled to the memory unit 540 and the plurality of I/O units 560 via the bus 530, all of which are powered by the PSU 550. It should be understood that, in some embodiments, each disclosed unit may actually be a plurality of such units for the purposes of redundancy, high availability, and/or performance. The combination of the presently disclosed units is configured to perform the stages any method disclosed herein.

FIG. 5 is a block diagram of a system including computing device 500. Consistent with an embodiment of the disclosure, the aforementioned CPU 520, the bus 530, the memory unit 540, a PSU 550, and the plurality of I/O units 560 may be implemented in a computing device, such as computing device 500 of FIG. 5. Any suitable combination of hardware, software, or firmware may be used to implement the aforementioned units. For example, the CPU 520, the bus 530, and the memory unit 540 may be implemented with computing device 500 or any of other computing devices 500, in combination with computing device 500. The aforementioned system, device, and components are examples and other systems, devices, and components may comprise the aforementioned CPU 520, the bus 530, the memory unit 540, consistent with embodiments of the disclosure.

The One or more computing devices 500 may be embodied as any of the computing elements illustrated in FIGS. 1 and 2, including, but not limited to, client devices 110a and 110b, which may be collectively referred to as client device 110, wireless cellular network 120, network 125, server 130, data storage 135, and electronically customizable article 115 with display 117 such as User and Admin interfaces; Recognition Module, Content Module, Analysis Module and neural net. A computing device 500 does not need to be electronic, nor even have a CPU 520, nor bus 530, nor memory unit 540. The definition of the computing device 500 to a person having ordinary skill in the art is “A device that computes, especially a programmable [usually] electronic machine that performs high-speed mathematical or logical operations or that assembles, stores, correlates, or otherwise processes information.” Any device which processes information qualifies as a computing device 500, especially if the processing is purposeful.

With reference to FIG. 5, a system consistent with an embodiment of the disclosure may include a computing device, such as computing device 500. In a basic configuration, computing device 500 may include at least one clock module 510, at least one CPU 520, at least one bus 530, and at least one memory unit 540, at least one PSU 550, and at least one I/O 560 module, wherein I/O module may be comprised of, but not limited to a non-volatile storage sub-module 561, a communication sub-module 562, a sensors sub-module 563, and a peripherals sub-module 564.

A system consistent with an embodiment of the disclosure the computing device 500 may include the clock module 510 may be known to a person having ordinary skill in the art as a clock generator, which produces clock signals. Clock signal is a particular type of signal that oscillates between a high and a low state and is used like a metronome to coordinate actions of digital circuits. Most integrated circuits (ICs) of sufficient complexity use a clock signal in order to synchronize different parts of the circuit, cycling at a rate slower than the worst-case internal propagation delays. The preeminent example of the aforementioned integrated circuit is the CPU 520, the central component of modern computers, which relies on a clock. The only exceptions are asynchronous circuits such as asynchronous CPUs. The clock 510 can comprise a plurality of embodiments, such as, but not limited to, single-phase clock which transmits all clock signals on effectively 1 wire, two-phase clock which distributes clock signals on two wires, each with non-overlapping pulses, and four-phase clock which distributes clock signals on 4 wires.

Many computing devices 500 use a “clock multiplier” which multiplies a lower frequency external clock to the appropriate clock rate of the CPU 520. This allows the CPU 520 to operate at a much higher frequency than the rest of the computer, which affords performance gains in situations where the CPU 520 does not need to wait on an external factor (like memory 540 or input/output 560). Some embodiments of the clock 510 may include dynamic frequency change, where, the time between clock edges can vary widely from one edge to the next and back again.

A system consistent with an embodiment of the disclosure the computing device 500 may include the CPU unit 520 comprising at least one CPU Core 521. A plurality of CPU cores 521 may comprise identical the CPU cores 521, such as, but not limited to, homogeneous multi-core systems. It is also possible for the plurality of CPU cores 521 to comprise different the CPU cores 521, such as, but not limited to, heterogeneous multi-core systems, big. LITTLE systems and some AMD accelerated processing units (APU). The CPU unit 520 reads and executes program instructions which may be used across many application domains, for example, but not limited to, general purpose computing, embedded computing, network computing, digital signal processing (DSP), and graphics processing (GPU). The CPU unit 520 may run multiple instructions on separate CPU cores 521 at the same time. The CPU unit 520 may be integrated into at least one of a single integrated circuit die and multiple dies in a single chip package. The single integrated circuit die and multiple dies in a single chip package may contain a plurality of other aspects of the computing device 500, for example, but not limited to, the clock 510, the CPU 520, the bus 530, the memory 540, and I/O 560.

The CPU unit 520 may contain cache 522 such as, but not limited to, a level 1 cache, level 2 cache, level 3 cache or combination thereof. The aforementioned cache 522 may or may not be shared amongst a plurality of CPU cores 521. The cache 522 sharing comprises at least one of message passing and inter-core communication methods may be used for the at least one CPU Core 521 to communicate with the cache 522. The inter-core communication methods may comprise, but not limited to, bus, ring, two-dimensional mesh, and crossbar. The aforementioned CPU unit 520 may employ symmetric multiprocessing (SMP) design.

The plurality of the aforementioned CPU cores 521 may comprise soft microprocessor cores on a single field programmable gate array (FPGA), such as semiconductor intellectual property cores (IP Core). The plurality of CPU cores 521 architecture may be based on at least one of, but not limited to, Complex instruction set computing (CISC), Zero instruction set computing (ZISC), and Reduced instruction set computing (RISC). At least one of the performance-enhancing methods may be employed by the plurality of the CPU cores 521, for example, but not limited to Instruction-level parallelism (ILP) such as, but not limited to, superscalar pipelining, and Thread-level parallelism (TLP).

Consistent with the embodiments of the present disclosure, the aforementioned computing device 500 may employ a communication system that transfers data between components inside the aforementioned computing device 500, and/or the plurality of computing devices 500. The aforementioned communication system will be known to a person having ordinary skill in the art as a bus 530. The bus 530 may embody internal and/or external plurality of hardware and software components, for example, but not limited to a wire, optical fiber, communication protocols, and any physical arrangement that provides the same logical function as a parallel electrical bus. The bus 530 may comprise at least one of, but not limited to a parallel bus, wherein the parallel bus carry data words in parallel on multiple wires, and a serial bus, wherein the serial bus carry data in bit-serial form. The bus 530 may embody a plurality of topologies, for example, but not limited to, a multidrop/electrical parallel topology, a daisy chain topology, and a connected by switched hubs, such as USB bus. The bus 530 may comprise a plurality of embodiments, for example, but not limited to
Internal data bus (data bus) 531/Memory bus
Control bus 532
Address bus 533
System Management Bus (SMBus)
Front-Side-Bus (FSB)
External Bus Interface (EBI)
Local bus
Expansion bus
Lightning bus
Controller Area Network (CAN bus)
Camera Link
ExpressCard
Advanced Technology management Attachment (ATA), including embodiments and derivatives such as, but not limited to, Integrated Drive Electronics (IDE)/Enhanced IDE (EIDE), ATA Packet Interface (ATAPI), Ultra-Direct Memory Access (UDMA), Ultra ATA (UATA)/Parallel ATA (PATA)/Serial ATA (SATA), CompactFlash (CF) interface, Consumer Electronics ATA (CE-ATA)/Fiber Attached Technology Adapted (FATA), Advanced Host Controller Interface (AHCI), SATA Express (SATAe)/External SATA (eSATA), including the powered embodiment eSATAp/Mini-SATA (mSATA), and Next Generation Form Factor (NGFF)/M.2.
Small Computer System Interface (SCSI)/Serial Attached SCSI (SAS)
HyperTransport
InfiniBand
RapidIO
Mobile Industry Processor Interface (MIPI)
Coherent Processor Interface (CAPI)
Plug-n-play
1-Wire
Peripheral Component Interconnect (PCI), including embodiments such as, but not limited to, Accelerated Graphics Port (AGP), Peripheral Component Interconnect eXtended (PCI-X), Peripheral Component Interconnect Express (PCI-e) (i.g. PCI Express Mini Card, PCI Express M.2 [Mini PCIe v2], PCI Express External Cabling [ePCIe], and PCI Express OCuLink [Optical Copper{Cu} Link]), Express Card, AdvancedTCA, AMC, Universal 10, Thunderbolt/Mini DisplayPort, Mobile PCIe (M-PCIe), U.2, and Non-Volatile Memory Express (NVMe)/Non-Volatile Memory Host Controller Interface Specification (NVMHCIS).
Industry Standard Architecture (ISA), including embodiments such as, but not limited to Extended ISA (EISA), PC/XT-bus/PC/AT-bus/PC/104 bus (e.g. PC/104-Plus, PCI/104-Express, PCI/104, and PCI-104), and Low Pin Count (LPC).
Music Instrument Digital Interface (MIDI)
Universal Serial Bus (USB), including embodiments such as, but not limited to, Media Transfer Protocol (MTP)/Mobile High-Definition Link (MHL), Device Firmware Upgrade (DFU), wireless USB, InterChip USB, IEEE 1394 Interface/Firewire, Thunderbolt, and eXtensible Host Controller Interface (xHCI).

Consistent with the embodiments of the present disclosure, the aforementioned computing device 500 may employ hardware integrated circuits that store information for immediate use in the computing device 500, know to the person having ordinary skill in the art as primary storage or memory 540. The memory 540 operates at high speed, distinguishing it from the non-volatile storage sub-module 561, which may be referred to as secondary or tertiary storage, which provides slow-to-access information but offers higher capacities at lower cost. The contents contained in memory 540, may be transferred to secondary storage via techniques such as, but not limited to, virtual memory and swap. The memory 540 may be associated with addressable semiconductor memory, such as integrated circuits consisting of silicon-based transistors, used for example as primary storage but also other purposes in the computing device 500. The memory 540 may comprise a plurality of embodiments, such as, but not limited to volatile memory, non-volatile memory, and semi-volatile memory. It should be understood by a person having ordinary skill in the art that the ensuing are non-limiting examples of the aforementioned memory:
Volatile memory which requires power to maintain stored information, for example, but not limited to, Dynamic Random-Access Memory (DRAM) 541, Static Random-Access Memory (SRAM) 542, CPU Cache memory 525, Advanced Random-Access Memory (A-RAM), and other types of primary storage such as Random-Access Memory (RAM).
Non-volatile memory which can retain stored information even after power is removed, for example, but not limited to, Read-Only Memory (ROM) 543, Programmable ROM (PROM) 544, Erasable PROM (EPROM) 545, Electrically Erasable PROM (EEPROM) 546 (e.g. flash memory and Electrically Alterable PROM [EAPROM]), Mask ROM (MROM), One Time Programable (OTP) ROM/Write Once Read Many (WORM), Ferroelectric RAM (FeRAM), Parallel Random-Access Machine (PRAM), Split-Transfer Torque RAM (STT-RAM), Silicon Oxime Nitride Oxide Silicon (SONOS), Resistive RAM (RRAM), Nano RAM (NRAM), 3D XPoint, Domain-Wall Memory (DWM), and millipede memory.
Semi-volatile memory which may have some limited non-volatile duration after power is removed but loses data after said duration has passed. Semi-volatile memory provides high performance, durability, and other valuable characteristics typically associated with volatile memory, while providing some benefits of true non-volatile memory. The semi-volatile memory may comprise volatile and non-volatile memory and/or volatile memory with battery to provide power after power is removed. The semi-volatile memory may comprise, but not limited to spin-transfer torque RAM (STT-RAM).

Consistent with the embodiments of the present disclosure, the aforementioned computing device 500 may employ the communication system between an information processing system, such as the computing device 500, and the outside world, for example, but not limited to, human, environment, and another computing device 500. The aforementioned communication system will be known to a person having ordinary skill in the art as I/O 560. The I/O module 560 regulates a plurality of inputs and outputs with regard to the computing device 500, wherein the inputs are a plurality of signals and data received by the computing device 500, and the outputs are the plurality of signals and data sent from the computing device 500. The I/O module 560 interfaces a plurality of hardware, such as, but not limited to, non-volatile storage 561, communication devices b, sensors 563, and peripherals 564. The plurality of hardware is used by the at least one of, but not limited to, human, environment, and another computing device 500 to communicate with the present computing device 500. The I/O module 560 may comprise a plurality of forms, for example, but not limited to channel I/O, port-mapped I/O, asynchronous I/O, and Direct Memory Access (DMA).

Consistent with the embodiments of the present disclosure, the aforementioned computing device 500 may employ the non-volatile storage sub-module 561, which may be referred to by a person having ordinary skill in the art as one of secondary storage, external memory, tertiary storage, off-line storage, and auxiliary storage. The non-volatile storage sub-module 561 may not be accessed directly by the CPU 520 without using intermediate area in the memory 540. The non-volatile storage sub-module 561 does not lose data when power is removed and may be two orders of magnitude less costly than storage used in memory module, at the expense of speed and latency. The non-volatile storage sub-module 561 may comprise a plurality of forms, such as, but not limited to, Direct Attached Storage (DAS), Network Attached Storage (NAS), Storage Area Network (SAN), nearline storage, Massive Array of Idle Disks (MAID), Redundant Array of Independent Disks (RAID), device mirroring, off-line storage, and robotic storage. The non-volatile storage sub-module (561) may comprise a plurality of embodiments, such as, but not limited to:
Optical storage, for example, but not limited to, Compact Disk (CD) (CD-ROM/CD-R/CD-RW), Digital Versatile Disk (DVD) (DVD-ROM/DVD-R/DVD+R/DVD-RW/DVD+RW/DVD+RW/DVD+R DL/DVD-RAM/HD-DVD), Blu-ray Disk (BD) (BD-ROM/BD-R/BD-RE/BD-R DL/BD-RE DL), and Ultra-Density Optical (UDO)
Semiconductor storage, for example, but not limited to, flash memory, such as, but not limited to, USB flash drive, Memory card, Subscriber Identity Module (SIM) card, Secure Digital (SD) card, Smart Card, CompactFlash (CF) card, and Solid State Drive (SSD) and memristor
Magnetic storage such as, but not limited to, Hard Disk Drive (HDD), tape drive, carousel memory, and Card Random-Access Memory (CRAM).
Phase-change memory
Holographic data storage such as Holographic Versatile Disk (HVD)
Molecular Memory
Deoxyribonucleic Acid (DNA) digital data storage

Consistent with the embodiments of the present disclosure, the aforementioned computing device 500 may employ the communication sub-module 562 as a subset of the I/O 560, which may be referred to by a person having ordinary skill in the art as at least one of, but not limited to, computer network, data network, and network. The network allows computing devices 500 to exchange data using connections, which may be known to a person having ordinary skill in the art as data links, between network nodes. The nodes comprise network computer devices 500 that originate, route, and terminate data. The nodes are identified by network addresses and can include a plurality of hosts consistent with the embodiments of a computing device 500. The aforementioned embodiments include, but not limited to personal computers, phones, servers, drones, and networking devices such as, but not limited to, hubs, switches, routers, modems, and firewalls.

Two nodes can be said are networked together, when one computing device 500 is able to exchange information with the other computing device 500, whether or not they have a direct connection with each other. The communication sub-module 562 supports a plurality of applications and services, such as, but not limited to World Wide Web (WWW), digital video and audio, shared use of application and storage computing devices 500, printers/scanners/fax machines, email/online chat/instant messaging, remote control, etc. The network may comprise a plurality of transmission mediums, such as, but not limited to conductive wire, fiber optics, and wireless. The network may comprise a plurality of communications protocols to organize network traffic, wherein application-specific communications protocols are layered, may be known to a person having ordinary skill in the art as carried as payload, over other more general communications protocols. The plurality of communications protocols may comprise, but not limited to, IEEE 802, ethernet, Wireless LAN (WLAN/Wi-Fi), Internet Protocol (IP) suite (e.g. TCP/IP, UDP, Internet

Protocol version 4 [IPv4], and Internet Protocol version 6 [IPv6]), Synchronous Optical Networking (SONET)/Synchronous Digital Hierarchy (SDH), Asynchronous Transfer Mode (ATM), and cellular standards (e.g. Global System for Mobile Communications [GSM], General Packet Radio Service [GPRS], Code-Division Multiple Access [CDMA], and Integrated Digital Enhanced Network [IDEN]).

The communication sub-module 562 may comprise a plurality of size, topology, traffic control mechanism and organizational intent. The communication sub-module 562 may comprise a plurality of embodiments, such as, but not limited to
Wired communications, such as, but not limited to, coaxial cable, phone lines, twisted pair cables (ethernet), and InfiniBand.
Wireless communications, such as, but not limited to, communications satellites, cellular systems, radio frequency/spread spectrum technologies, IEEE 802.11 Wi-Fi, Bluetooth, NFC, free-space optical communications, terrestrial microwave, and Infrared (IR) communications. Wherein cellular systems embody technologies such as, but not limited to, 3G,4G (such as WiMax and LTE), and 5G
Parallel communications, such as, but not limited to, LPT ports.
Serial communications, such as, but not limited to, RS-232 and USB
Fiber Optic communications, such as, but not limited to, Single-mode optical fiber (SMF) and Multi-mode optical fiber (MMF)
Power Line communications

The aforementioned network may comprise a plurality of layouts, such as, but not limited to, bus network such as ethernet, star network such as Wi-Fi, ring network, mesh network, fully connected network, and tree network. The network can be characterized by its physical capacity or its organizational purpose. Use of the network, including user authorization and access rights, differ accordingly. The characterization may include, but not limited to nanoscale network, Personal Area Network (PAN), Local Area Network (LAN), Home Area Network (HAN), Storage Area Network (SAN), Campus Area Network (CAN), backbone network, Metropolitan Area Network (MAN), Wide Area Network (WAN), enterprise private network, Virtual Private Network (VPN), and Global Area Network (GAN).

Consistent with the embodiments of the present disclosure, the aforementioned computing device 500 may employ the sensors sub-module 563 as a subset of the I/O 560. The sensors sub-module 563 comprises at least one of the devices, modules, and subsystems whose purpose is to detect events or changes in its environment and send the information to the computing device 500. Sensors are sensitive to the measured property, are not sensitive to any property not measured, but may be encountered in its application, and do not significantly influence the measured property. The sensors sub-module 563 may comprise a plurality of digital devices and analog devices, wherein if an analog device is used, an Analog to Digital (A-to-D) converter must be employed to interface the said device with the computing device 500. The sensors sub-module 563 may comprise a plurality of embodiments, such as, but not limited to, chemical sensors, automotive sensors, acoustic/sound/vibration sensors, electric current/electric potential/magnetic/radio sensors, environmental/weather/moisture/humidity sensors, flow/fluid velocity sensors, ionizing radiation/particle sensors, navigation sensors, position/angle/displacement/distance/speed/acceleration sensors, imaging/optical/light sensors, pressure sensors, force/density/level sensors, thermal/temperature sensors, and proximity/presence sensors. It should be understood by a person having ordinary skill in the art that the ensuing are non-limiting examples of the aforementioned sensors:
Chemical sensors, such as, but not limited to, breathalyzer, carbon dioxide sensor, carbon monoxide/smoke detector, catalytic bead sensor, chemical field-effect transistor, chemiresistor, electrochemical gas sensor, electronic nose, electrolyte-insulator-semiconductor sensor, energy-dispersive X-ray spectroscopy, fluorescent chloride sensors, holographic sensor, hydrocarbon dew point analyzer, hydrogen sensor, hydrogen sulfide sensor, infrared point sensor, ion-selective electrode, nondispersive infrared sensor, microwave chemistry sensor, nitrogen oxide sensor, olfactometer, optode, oxygen sensor, ozone monitor, pellistor, pH glass electrode, potentiometric sensor, redox electrode, zinc oxide nanorod sensor, and biosensors (such as nanosensors).
Automotive sensors, such as, but not limited to, air flow meter/mass airflow sensor, air-fuel ratio meter, AFR sensor, blind spot monitor, engine coolant/exhaust gas/cylinder head/transmission fluid temperature sensor, hall effect sensor, wheel/automatic transmission/turbine/vehicle speed sensor, airbag sensors, brake fluid/engine crankcase/fuel/oil/tire pressure sensor, camshaft/crankshaft/throttle position sensor, fuel/oil level sensor, knock sensor, light sensor, MAP sensor, oxygen sensor (o2), parking sensor, radar sensor, torque sensor, variable reluctance sensor, and water-in-fuel sensor.
Acoustic, sound and vibration sensors, such as, but not limited to, microphone, lace sensor (guitar pickup), seismometer, sound locator, geophone, and hydrophone.
Electric current, electric potential, magnetic, and radio sensors, such as, but not limited to, current sensor, Daly detector, electroscope, electron multiplier, faraday cup, galvanometer, hall effect sensor, hall probe, magnetic anomaly detector, magnetometer, magnetoresistance, MEMS magnetic field sensor, metal detector, planar hall sensor, radio direction finder, and voltage detector.
Environmental, weather, moisture, and humidity sensors, such as, but not limited to, actinometer, air pollution sensor, bedwetting alarm, ceilometer, dew warning, electrochemical gas sensor, fish counter, frequency domain sensor, gas detector, hook gauge evaporimeter, humistor, hygrometer, leaf sensor, lysimeter, pyranometer, pyrgeometer, psychrometer, rain gauge, rain sensor, seismometers, SNOTEL, snow gauge, soil moisture sensor, stream gauge, and tide gauge.
Flow and fluid velocity sensors, such as, but not limited to, air flow meter, anemometer, flow sensor, gas meter, mass flow sensor, and water meter.
Ionizing radiation and particle sensors, such as, but not limited to, cloud chamber, Geiger counter, Geiger-Muller tube, ionization chamber, neutron detection, proportional counter, scintillation counter, semiconductor detector, and thermoluminescent dosimeter.
Navigation sensors, such as, but not limited to, air speed indicator, altimeter, attitude indicator, depth gauge, fluxgate compass, gyroscope, inertial navigation system, inertial reference unit, magnetic compass, MHD sensor, ring laser gyroscope, turn coordinator, variometer, vibrating structure gyroscope, and yaw rate sensor.
Position, angle, displacement, distance, speed, and acceleration sensors, such as, but not limited to, accelerometer, displacement sensor, flex sensor, free fall sensor, gravimeter, impact sensor, laser rangefinder, LIDAR, odometer, photoelectric sensor, position sensor such as GPS or Glonass, angular rate sensor, shock detector, ultrasonic sensor, tilt sensor, tachometer, ultra-wideband radar, variable reluctance sensor, and velocity receiver.
Imaging, optical and light sensors, such as, but not limited to, CMOS sensor, colorimeter, contact image sensor, electro-optical sensor, infra-red sensor, kinetic inductance detector, LED as light sensor, light-addressable potentiometric sensor, Nichols radiometer, fiber-optic sensors, optical position sensor, thermopile laser sensor, photodetector, photodiode, photomultiplier tubes, phototransistor, photoelectric sensor, photoionization detector, photomultiplier, photoresistor, photoswitch, phototube, scintillometer, Shack-Hartmann, single-photon avalanche diode, superconducting nanowire single-photon detector, transition edge sensor, visible light photon counter, and wavefront sensor.
Pressure sensors, such as, but not limited to, barograph, barometer, boost gauge, bourdon gauge, hot filament ionization gauge, ionization gauge, McLeod gauge, Oscillating U-tube, permanent downhole gauge, piezometer, Pirani gauge, pressure sensor, pressure gauge, tactile sensor, and time pressure gauge.
Force, Density, and Level sensors, such as, but not limited to, bhangmeter, hydrometer, force gauge/force sensor, level sensor, load cell, magnetic level/nuclear density/strain gauge, piezocapacitive pressure sensor, piezoelectric sensor, torque sensor, and viscometer.
Thermal and temperature sensors, such as, but not limited to, bolometer, bimetallic strip, calorimeter, exhaust gas temperature gauge, flame detection/pyrometer, Gardon gauge, Golay cell, heat flux sensor, microbolometer, microwave radiometer, net radiometer, infrared/quartz/resistance thermometer, silicon bandgap temperature sensor, thermistor, and thermocouple.
Proximity and presence sensors, such as, but not limited to, alarm sensor, doppler radar, motion detector, occupancy sensor, proximity sensor, passive infrared sensor, reed switch, stud finder, triangulation sensor, touch switch, and wired glove.

Consistent with the embodiments of the present disclosure, the aforementioned computing device 500 may employ the peripherals sub-module 562 as a subset of the I/O 560. The peripheral sub-module 564 comprises ancillary devices uses to put information into and get information out of the computing device 500. There are 3 categories of devices comprising the peripheral sub-module 564, which exist based on their relationship with the computing device 500, input devices, output devices, and input/output devices. Input devices send at least one of data and instructions to the computing device 500. Input devices can be categorized based on, but not limited to:
Modality of input, such as, but not limited to, mechanical motion, audio, and visual
Whether the input is discrete, such as but not limited to, pressing a key, or continuous such as, but not limited to position of a mouse
The number of degrees of freedom involved, such as, but not limited to, two-dimensional mice vs three-dimensional mice used for Computer-Aided Design (CAD) applications

Output devices provide output from the computing device 500. Output devices convert electronically generated information into a form that can be presented to humans. Input/output devices perform that perform both input and output functions. It should be understood by a person having ordinary skill in the art that the ensuing are non-limiting embodiments of the aforementioned peripheral sub-module 564:
Input Devices
   Human Interface Devices (HID), such as, but not limited to, pointing device (e.g. mouse, touchpad, joystick, touchscreen, game controller/gamepad, remote, light pen, light gun, Wii remote, jog dial, shuttle, and knob), keyboard, graphics tablet, digital pen, gesture recognition devices, magnetic ink character recognition, Sip-and-Puff (SNP) device, and Language Acquisition Device (LAD).
   High degree of freedom devices, that require up to six degrees of freedom such as, but not limited to, camera gimbals, Cave Automatic Virtual Environment (CAVE), and virtual reality systems.
   Video Input devices are used to digitize images or video from the outside world into the computing device 500. The information can be stored in a multitude of formats depending on the user's requirement. Examples of types of video input devices include, but not limited to, digital camera, digital camcorder, portable media player, webcam, Microsoft Kinect, image scanner, fingerprint scanner, barcode reader, 3D scanner, laser rangefinder, eye gaze tracker, computed tomography, magnetic resonance imaging, positron emission tomography, medical ultrasonography, TV tuner, and iris scanner.
   Audio input devices are used to capture sound. In some cases, an audio output device can be used as an input device, in order to capture produced sound. Audio input devices allow a user to send audio signals to the computing device 500 for at least one of processing, recording, and carrying out commands. Devices such as microphones allow users to speak to the computer in order to record a voice message or navigate software. Aside from recording, audio input devices are also used with speech recognition software. Examples of types of audio input devices include, but not limited to microphone, Musical Instrumental Digital Interface (MIDI) devices such as, but not limited to a keyboard, and headset.
   Data AcQuisition (DAQ) devices covert at least one of analog signals and physical parameters to digital values for processing by the computing device 900. Examples of DAQ devices may include, but not limited to, Analog to Digital Converter (ADC), data logger, signal conditioning circuitry, multiplexer, and Time to Digital Converter (TDC).
Output Devices may further comprise, but not be limited to:
   Display devices, which convert electrical information into visual form, such as, but not limited to, monitor, TV, projector, and Computer Output Microfilm (COM). Display devices can use a plurality of underlying technologies, such as, but not limited to, Cathode-Ray Tube (CRT), Thin-Film Transistor (TFT), Liquid Crystal Display (LCD), Organic Light-Emitting Diode (OLED), MicroLED, and Refreshable Braille Display/Braille Terminal.
   Printers, such as, but not limited to, inkjet printers, laser printers, 3D printers, and plotters.
   Audio and Video (AV) devices, such as, but not limited to, speakers, headphones, and lights, which include lamps, strobes, DJ lighting, stage lighting, architectural lighting, special effect lighting, and lasers.
   Other devices such as Digital to Analog Converter (DAC)
Input/Output Devices may further comprise, but not be limited to, touchscreens, networking device (e.g. devices disclosed in network 562 sub-module), data storage device (non-volatile storage 561), facsimile (FAX), and graphics/sound cards.

All rights including copyrights in the code included herein are vested in and the property of the Applicant. The Applicant retains and reserves all rights in the code included herein, and grants permission to reproduce the material only in connection with reproduction of the granted patent and for no other purpose.

The following disclose various Aspects of the present disclosure. The various Aspects are not to be construed as patent claims unless the language of the Aspect appears as a patent claim. The Aspects describe various non-limiting embodiments of the present disclosure.

Aspect 1. An electronically customizable article comprising:

a fashion article selected from the group consisting of a handbag, a shoe, glasses, a tie, and a bowtie wherein the fashion article comprises an electronic visual display, a processor, a communication interface for communication between the fashion article and a network, and a non-transitory computer readable medium containing instructions that when executed by the processor, causes the fashion article to connect to a server over the network, receive data from the server, and display one or more images associated with the data on the electronic visual display.

Aspect 2. The electronically customizable article of aspect 1 wherein the electronic visual display is a touch screen display.

Aspect 3. The electronically customizable article of aspect 1 wherein the electronic visual display is configured to rotate a display on the electronic visual display based on the position of the electronically customizable article.

Aspect 4. The electronically customizable article of aspect 1 wherein the electronic visual display at multiple locations on the fashion article.

Aspect 5. The electronically customizable article of aspect 1 wherein the data received from the server includes data associated with an email.

Aspect 6. The electronically customizable article of aspect 1 wherein the data received from the server includes data associated with a text message.

Aspect 7. The electronically customizable article of aspect 1 wherein the data received from the server includes data associated with a news feed.

Aspect 8. The electronically customizable article of aspect 1 wherein the data received from the server includes data associated with a video.

Aspect 9. The electronically customizable article of aspect 1 wherein the data received from the server includes data associated with a video game.

Aspect 10. The electronically customizable article of aspect 1 the server is a social media server and the electronically customizable article is configured to display social media content.

Aspect 11. The electronically customizable article of aspect 1 further comprising a video capture device for recording video wherein the electronically customizable article is configured to playback the captured video on the electronic visual display.

Aspect 12. The electronically customizable article of aspect 1 further configured to receive data from the server wherein the data is associated with an audio, and configured to playback the audio file on an integrated speaker.

Aspect 13. An electronically customizable article comprising:

a fashion article selected from the group consisting of a handbag, a shoe, glasses, a tie, and a bowtie wherein the fashion article comprises an electronic visual display, a processor, a I/O interface for communication between the fashion article and I/O device, and a non-transitory computer readable medium containing instructions that when executed by the processor, causes the fashion article to connect to the I/O device, receive data from I/O device, and display one or more images associated with the data on the electronic visual display.

Aspect 14. The electronically customizable article of aspect 13 wherein the I/O device is a camera.

Aspect 15. The electronically customizable article of aspect 13 wherein the I/O device is a mobile device and displays notification of incoming calls, text messages, or email messages.

Aspect 16. The electronically customizable article of aspect 13 wherein the I/O device is another electronically customizable article.

Aspect 17. An electronically customizable article comprising:

a fashion article selected from the group consisting of a handbag, a shoe, glasses, a tie, and a bowtie wherein the fashion article comprises an electronic visual display, a processor, and a non-transitory computer readable medium containing instructions that when executed by the processor, causes the fashion article to function as a handheld device.

Aspect 18. The electronically customizable article of aspect 17 wherein the handheld device is a tablet-style computer.

Aspect 19. The electronically customizable article of aspect 17 wherein the handheld device is a mobile phone.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

The following is claimed:

1. An apparatus comprising:
a fashion article selected from the group consisting of the following: a handbag, shoes, glasses, a tie, a bowtie, a bracelet, a necklace, earrings, a ring, a garment, a name tag, a belt, a wallet, and optical frame, the fashion article comprising:
an electronic visual multi touch-sensitive hand writing recognition capable display integral with the fashion article,
a sound sensor,
at least one camera,
a processor,
a biometric component, wherein the biometric component is configured to operate the electronically customizable article,
a location component, wherein the location component comprises at least one of a GPS receiver, a Bluetooth locator, and a Wi-Fi locator,
a communication interface for communication between the fashion article and a network, and
a non-transitory computer readable medium containing instructions that, when executed by the processor, causes the fashion article to:
display visual content on the electronic multi touch-sensitive hand writing recognition capable display,
wherein the visual content comprises at least one of the following: an image, video, color, pattern and design, and further comprising a user selected set of images,
receive sensor data, wherein the received sensor data comprises visual input from the camera, audio data and location information,
manipulate the visual content to make the user selected set of images contextually relevant based on the visual input from the camera, wherein a modification comprises matching the user selected set of images based on the received visual input and wherein the electronic visual display is placed in a locked position thereby disabling accidental navigation while only displaying one or more of the user selected set of images,
wherein the fashion article is further configured to, in response to the received sensor data:
modify the visual content based on the audio data, wherein a modification comprises a visual simulation of displayed visual content based on audio data,
provide one or more audible notifications based on the location information, and
provide one or more visual notifications based on the location information.

2. The electronically customizable article of claim 1, wherein the electronic visual display is a touch screen display.

3. The electronically customizable article claim 1, wherein the data received from the server includes data associated with at least one of the following: an image, color pattern and design.

4. An electronically customizable article comprising:
a fashion article selected from the group consisting of a handbag, a shoe, glasses, a tie, and a bowtie wherein the fashion article comprises an electronic visual display, a processor, and a non-transitory computer readable medium containing instructions that, when executed by the processor, causes the fashion article to function as a handheld device.

5. The electronically customizable article of claim 4, wherein the handheld device is a tablet-style computer.

6. The electronically customizable article of claim 4, wherein the handheld device is a mobile phone.
